(19) United States
(12) Patent Application Publication
(10) Pub. No.: US 2006/0209880 A1
(43) Pub. Date: Sep. 21, 2006

(54) Method of audio data transmission and system thereof

(75) Inventors: Andrew C. Chang, Hsinchu City (TW); Ching Yeh Hsuan, Taipei City (TW); Chih-Hao Hsiao, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/009,795

(22) Filed: Dec. 10, 2004

(51) Int. Cl. H04J 15/00; H04J 1/00

(52) U.S. Cl. 370/464; 370/490

(57) ABSTRACT

In an embodiment, a transmitter generates a self-generated video signal when retrieving only audio input signal from an audio source to replace an video input signal expected by the HDMI system. In another embodiment, a transmitter sets a flag when retrieving only an audio input signal, wherein the flag configures preamble transmitted in control periods to allow audio data to be transmitted to a receiver without incorporated with video data.

### BACKGROUND

The invention relates to high-definition multimedia interface (HDMI), and more specifically, to methods and systems for transmission of audio data that is originally not associated with video data using HDMI.

HDMI, an industry-supported, uncompressed, all-digital audio/video interface, provides an interface between a source device, such as a set-top box, digital video disc (DVD) player, computer, or a digital-video home system (D-VHS), and a destination device, such as a digital television (DTV), projector, plasma panel or a liquid crystal display (LCD) display. HDMI integrates audio and video information into a single digital interface. HDMI development is overseen by the HDMI Working Group, including Hitachi, Panasonic, Philips, Sony, Thomson (RCA), Toshiba, and Silicon Image. LLC, a subsidiary of Intel, as developed High-bandwidth Digital Content Protection (HDCP) for HDMI, providing a secure audio/video interface that meets the security requirements of content providers and system operators.

As an example shown in FIG. 1, a DVD player 12 is connected to a digital television or monitor 14 via an HDMI cable 13. A DVD player 12 comprises an MPEG decoder chip 122 and an HDMI transmitter chip 124. The MPEG decoder chip 122 acquires video data 161 and audio data 181 from a video source 16 and audio source 18 respectively. The HDMI transmitter chip 124 receives decoded video data 123a (such as 24-bit RGB) and decoded audio data 123b from the MPEG decoder chip 122, and encrypts the decoded video data 123a and decoded audio data 123b in a HDCP encryption block 1242. The encrypted HDMI data is output to the HDMI cable 13 and sent to an HDMI receiver 142 in the digital television 14. The HDMI receiver 142 comprises a corresponding HDCP decryption block 1422 for decrypting the received HDMI data. The HDMI receiver 14 recovers the received HDMI data and outputs the recovered video data 143a and audio data 143b.

HDMI utilizes core technologies provided by the Digital Visual Interface (DVI). DVI is a 24-bit RGB interface, which utilizes transition minimized differential signaling (TMDS). TMDS is a signaling technique that produces a transition controlled, DC balanced series of characters from an input series of data bytes. In a long string of logic zeros and logic ones, bits are selectively manipulated to maintain a particular DC biased signal. A DVI link utilizes three pairs of differential digital signals, each pair carrying low voltage signals representative of the red (R), green (G), and blue (B) signal components. A fourth pair of wires carries a pixel clock signal. A serial 8-bit RGB signal carries information at a speed of up to 1.65 Gbps with an aggregate link speed of 4.95 Gbps, but an effective transfer rate of 3.96 Gbps. A 10 bit encoding scheme is utilized to minimize transitions at such high data rates.

HDMI has potential beyond the scope of DVI. The HDMI specifications allow up to 5 Gbps bandwidth, compatible with future technology expansions, as current uncompressed HD movies only require 2.2 Gbps for both multi-channel audio and video. DVI has drawbacks that can be solved by HDMI, for example, DVI does not support digital audio data and digital chrominance signals (YCbCr). HDMI is fully backward-compatible with DVI using the CEA-861 profile for DTVs, however, the limitation of DVI makes a DVI device connected to an HDMI device unable to provide audio capability. One of the most important capabilities of HDMI is the ability to carry digital multi-channel audio in addition to digital video.

HDMI has the capability to support existing high-definition video formats (720 p, 1080 i, and 1080 p). It also has the flexibility to support enhanced definition formats such as 480 p and 576 p, as well as standard definition formats such as National Television System Committee (NTSC) or Phase Alternating Line (PAL). The HDMI specifications allow for up to 8 channels of audio with 24 bits at sampling rates for up to 192 kHz, supporting all current forms of pulse code modulation (PCM) audio including DVD-Audio and compressed audio formats. HDMI allows connection from source to receiver, or receiver to display, all via one cable type for both video and audio.

### SUMMARY

The invention provides methods and systems for transmission of audio data that is originally not associated with video data using High-definition Multimedia Interface (HDMI). In one embodiment, an HDMI transmitting system receives audio input signal, and self-generates video signal if the video input signal is absence. The HDMI transmitting system thus transmits audio data in data island periods and self-generated video data in video data periods. According to the HDMI specification, audio must be transmitted and played with video, such that the self-generated video data provided by the HDMI transmitting system replaces the absent input video data expected by the HDMI system. The audio data is transmitted in the data island periods within periods of horizontal or vertical blanking. Exemplary self-generated video data is a static (or still) picture, such as a logo or a trademark.

In another embodiment, an HDMI transmitting system receives an audio input signal, and sets a flag if a video input signal is not available. The HDMI transmitting system transmits audio data in data island periods within periods of horizontal or vertical blanking, and the flag configures the HDMI protocol to replace video data periods with data island periods and control periods. The flag extends horizontal or vertical blanking by configuring the beginning and end points thereof. The HDMI transmitting system can also send a signal instructing the corresponding HDMI receiver to turn off the display to conserve power.

### BRIEF DESCRIPTION OF THE DRAWINGS

The invention can be more fully understood by reading the subsequent detailed description in conjunction with the examples and references made to the accompanying drawings, wherein:

FIG. 1 is a schematic diagram illustrating a conventional HDMI system with HDCP protection scheme.

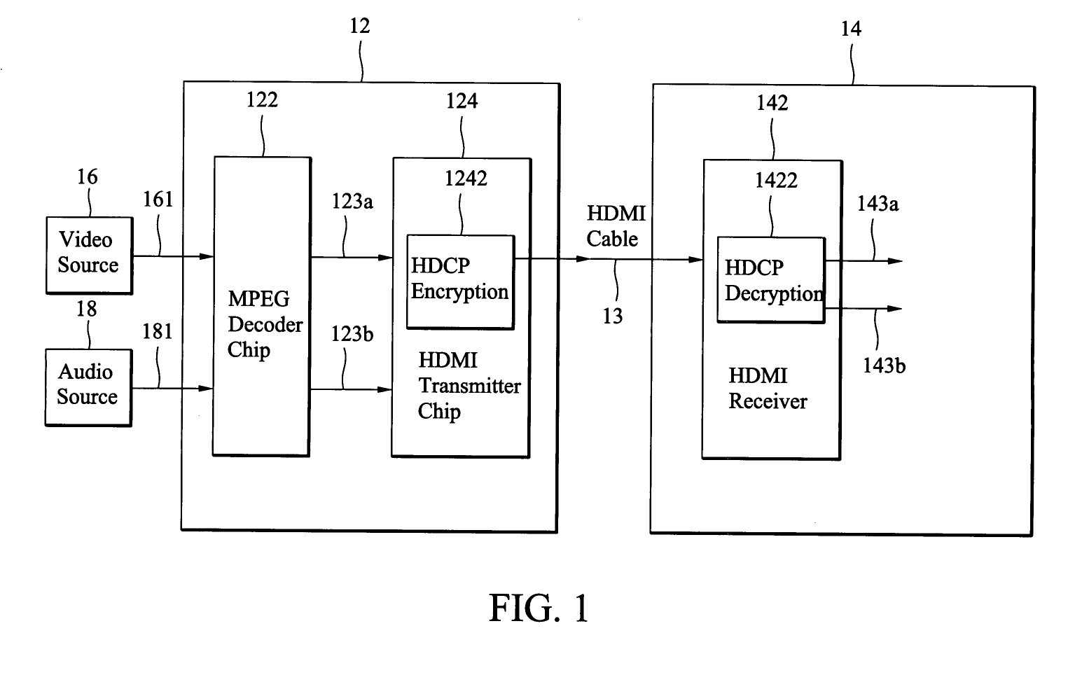

FIG. 2 is a block diagram of an HDMI system.

FIG. 3 shows an exemplary TMDS period placement in a 720×480 p video frame.

FIG. 4A is a block diagram illustrating an embodiment of a system for audio transmission using HDMI.

FIG. 4B is a block diagram illustrating an embodiment of a system for audio transmission using HDMI.

### DETAILED DESCRIPTION

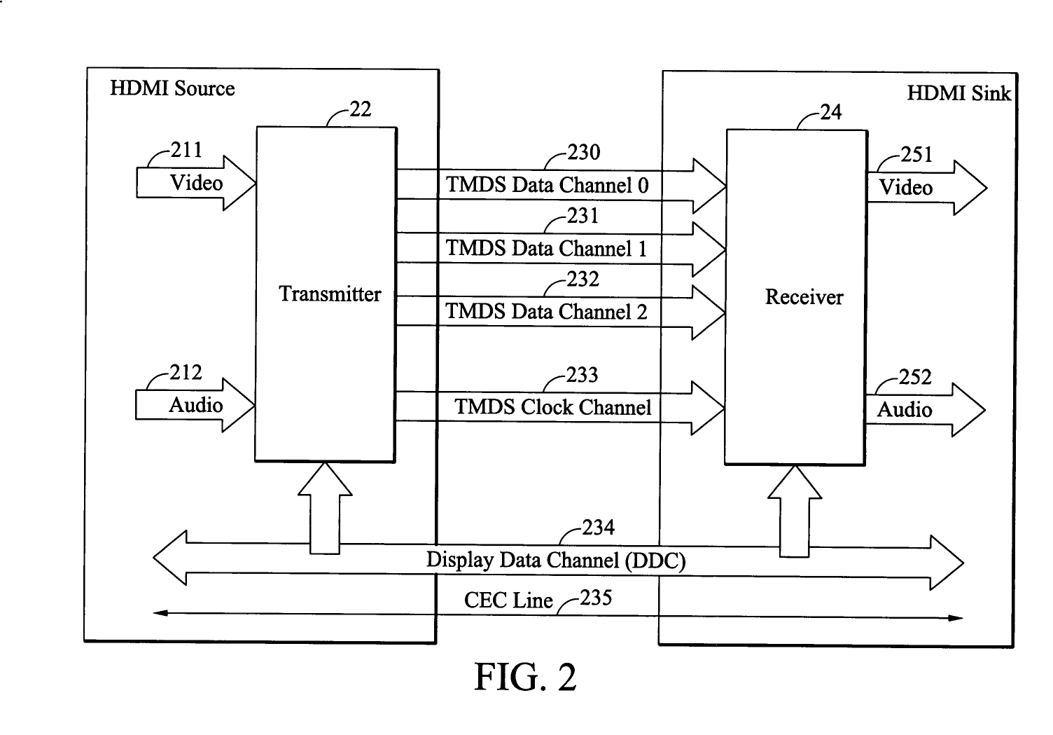

FIG. 2 is a block diagram of an HDMI system, comprising a plurality of sources and sinks, wherein an HDMI source denotes a device with an HDMI output, and an HDMI sink denotes a device with an HDMI input. As shown in FIG. 2, the HDMI cable and connectors carry four differential pairs that make up the transition minimized differential signaling (TMDS) clock channel 233 for carrying timing information for video data (“video pixel clock”), and three TMDS data channels 230˜232 carrying video data 211, audio data 212, and auxiliary data. The auxiliary data herein includes any data that is neither video data, audio data, nor timing information for video data, for example, timing information for audio data, text data, control signals for power supply, monitor control information (such as audio volume, brightness, or power state), and non-audio or video control information.

A video electronics standard association (VESA) display data channel (DDC) 234 configures and exchanges status between a single source and a single sink. An optional consumer electronics association (CEC) protocol provides high-level control functions between all audiovisual products in a user's environment. The video pixel clock is transmitted via the TMDS clock channel 233, and is used by the receiver 24 as a frequency reference for data recovery on the other three TMDS data channels 230˜232. In order to transmit audio data 212 and auxiliary data across the TMDS data channels 230˜232, HDMI uses a packet structure. As previously mentioned, the data can be protected with HDCP to attain higher reliability.

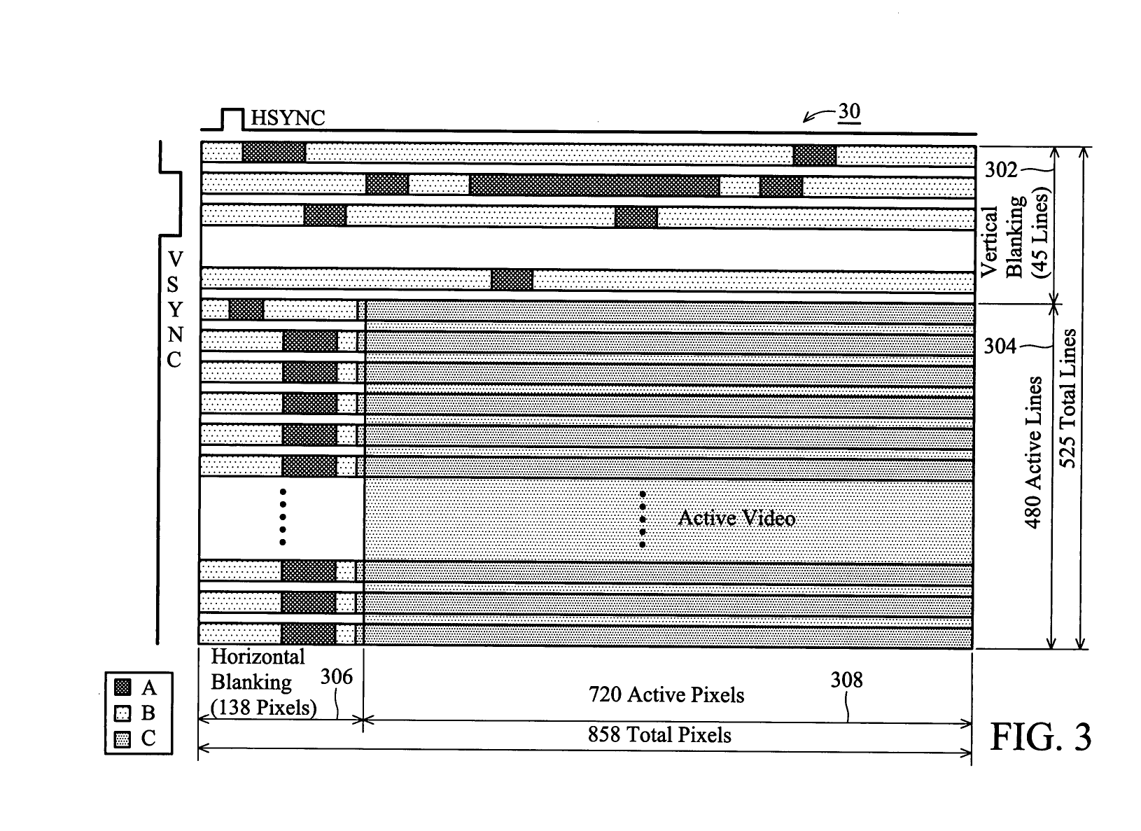

Various serial links for transmitting data and clock signals from a transmitter 22 to a receiver 24 are well known to those skilled in the art. One conventional serial links is known as a TMDS link, in which video data 211 are encoded and transmitted as encoded words, and the encoded video data and a video clock signal are transmitted as differential signals. The TMDS link operates in video data period, data island period, or control period. FIG. 3 depicts an exemplary TMDS period placement in a 720×480 p video frame 30. The active pixels of an active video line are transmitted during the video data periods, marked by pattern C in FIG. 3. Audio and auxiliary data is transmitted using a series of packets during data island periods, marked by pattern A. The control periods, marked by pattern B, are used when no video, audio, or auxiliary data needs to be transmitted, required between any other two periods.

As shown in FIG. 3, the primary data transmitted by a TMDS link are video data. The video data are not continuous, but with many blanking intervals, including vertical blanking 302 and horizontal blanking 306. These blanking intervals provide an opportunity for audio data and auxiliary data to be transported.

A preamble at the end of each control period indicates whether the next data period is a video data period or a data island period. Each video data period and data island period starts with a leading guard band providing determination of the transition from the control period to the data period.

As shown in FIG. 3, audio data is transmitted during data island periods within horizontal blanking 306 and vertical blanking 302. In conventional HDMI architecture, audio can only be transmitted along with video. The invention provides methods and systems allowing the audio data that is originally not associated with video data to be played by using an HDMI transmitter.

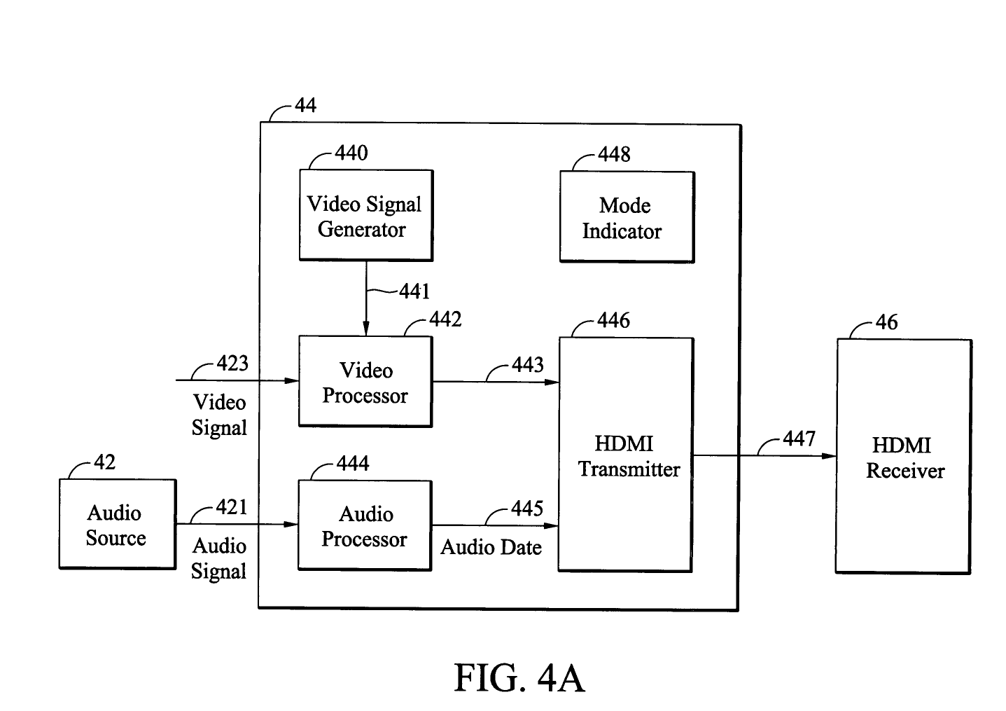

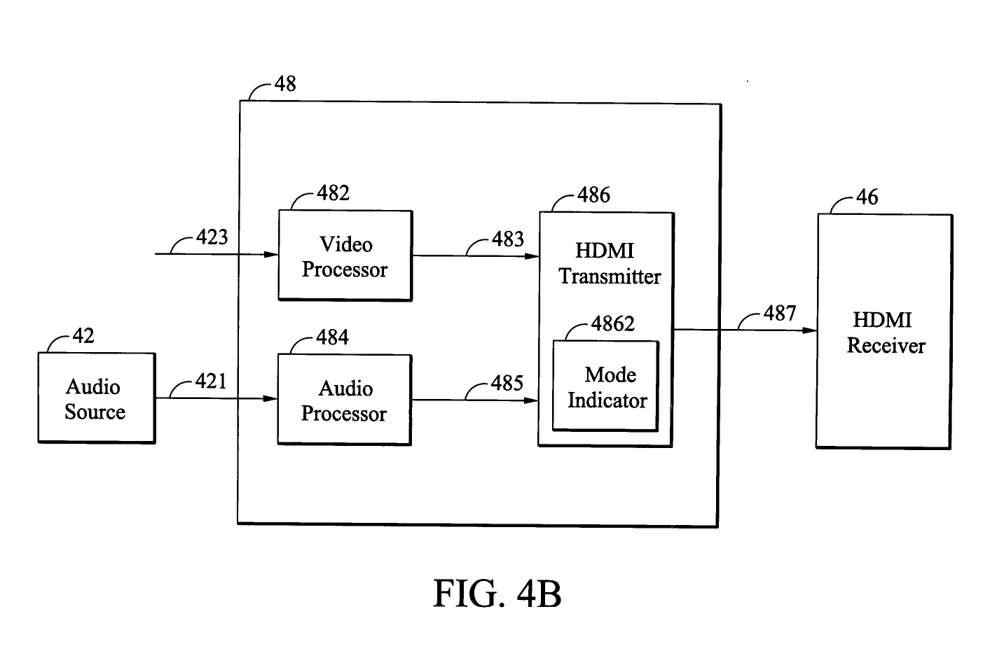

FIG. 4A is a block diagram illustrating an embodiment of a system for audio transmission using HDMI. As shown in FIG. 4A, an HDMI transmitting system 44 comprises an HDMI transmitter 446, an audio processor 444, a video processor 442, a video signal generator 440, and a mode indicator 448. The HDMI transmitting system 44 receives an audio input signal 421 from an audio source 42 and a video input signal 423 from a video source (not shown). The audio processor 444 receives and processes the audio input signal 421, such as digitizing, coding, and compressing the audio input signal 421, and subsequently outputs audio data 445 to the HDMI transmitter 446. The mode indicator 448, which could be a register or a control signal in practical implementation, is used to reflect if only audio input signal 421 is available or both audio input signal 421 and video input signal 423 are available. The video processor 442 receives either the external video input signal 423 or a self-generated video signal 441 output by the video signal generator 440 in accordance with the mode indicator 448. The video processor 442 processes the video signal, such as digitizing, coding, and compressing the video signal, and subsequently outputs video data 443 to the HDMI transmitter 446. The self-generated video signal 441 can carry any video, for example, a static picture such as a logo or a trademark. The HDMI transmitter 446 receives both the audio data 445 and the video data 443, and outputs an HDMI signal 447 to the HDMI receiver 46 through an HDMI cable.

FIG. 4B is a block diagram illustrating an embodiment of a system for audio transmission using HDMI. An HDMI transmitting system 48 comprises an HDMI transmitter 486, an audio processor 484, and a video processor 482. The HDMI system 44 receives an audio input signal 421 from an audio source 42 and a video input signal 423 from a video source (not shown). The audio processor 484 receives and processes the audio input signal 421, and subsequently outputs audio data 485 to the HDMI transmitter 486. The HDMI transmitter 486 comprises a mode indicator 4862, which could be a register or a control signal. The mode indicator 4862 reflects whether there is only audio input signal 421 available, or there are both audio input signal 421 and video input signal 423 available at the input of the HDMI system. The video processor 482 receives and processes the video input signal 423 and outputs video data 483 to the HDMI transmitter 486. The HDMI transmitter 486 receives the audio data 485 and the video data 483 if the input of the HDMI system contains both audio and video signals, and outputs an HDMI signal 487 to the HDMI receiver 46 through an HDMI cable. If the input of the HDMI system contains only audio signal, the mode indicator in the HDMI transmitter 486 sets a flag, and the HDMI transmitter 486 outputs an HDMI signal 487 to the HDMI receiver 46 according to the audio data 485. The flag configures the preamble transmitted in the control period to always arrange a data island period after each control period. The video frame thus contains only control period and data island periods. In other words, the periods of horizontal or vertical blanking are extended and the video data periods are omitted from the video frame. In some embodiments, the flag can also signal the HDMI receiver to turn off the display since there is no video data to be played, thereby conserving power.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for transmitting audio data using a High-definition Multimedia Interface (HDMI), comprising:
receiving input data;
self-generating video data if the input data contains no video data; and
transmitting the audio data in data island periods and the self-generated video data in video data periods.

2. The method according to claim 1, wherein the self-generated video data is a static picture.

3. A method for transmitting audio data using a High-definition Multimedia Interface (HDMI), comprising:
receiving input data;
setting a flag if the input data contains no video data;
configuring preambles transmitted in control periods to arrange a data island period after each control period once the flag is set; and
transmitting the audio data in data island periods.

4. The method according to claim 3, wherein the audio data is transmitted in the data island periods within horizontal blanking or vertical blanking periods.

5. The method according to claim 4, wherein the flag extends the horizontal blanking periods by configuring beginning and end points thereof.

6. The method according to claim 4, wherein the flag extends the vertical blanking periods by configuring beginning and end points thereof.

7. The method according to claim 3, further comprising instructing an HDMI receiver to turn off a display once the flag is set.

8. An HDMI transmitting system for transmitting audio data, comprising:
an audio processor, receiving and processing an audio input signal to generate audio data;
a video signal generator, generating a self-generated video signal if a video input signal is not available;
a mode indicator, reflecting if only the audio input signal is available or both audio and video input signals are available at the input of the HDMI transmitting system;
a video processor, receiving and processing the video input signal or the self-generated video signal to generate video data according to the mode indicator; and
an HDMI transmitter, receiving the audio and video data from the audio processor and video processor respectively, and outputting an HDMI signal carrying the audio data in data island periods and the video data in video data periods, respectively.

9. The HDMI transmitting system according to claim 8, wherein the self-generated video signal output from the video signal generator is a static picture.

10. An HDMI transmitting system for transmitting audio data, comprising:
an audio processor, receiving and processing an audio input signal to generate audio data; and
an HDMI transmitter, receiving the audio data from the audio processor and outputting an HDMI signal, comprising a mode indicator setting a flag if only the audio input signal is available at the input of the HDMI transmitting system, and outputting the HDMI signal comprising only data island periods and control periods if the flag is set.

11. The HDMI transmitting system according to claim 10, wherein the HDMI transmitter transmits the audio data in the data island periods within horizontal blanking or vertical blanking periods.

12. The HDMI transmitting system according to claim 11, wherein the flag extends the horizontal blanking periods by configuring beginning and end points thereof.

13. The HDMI transmitting system according to claim 11, wherein the flag extends the vertical blanking periods by configuring beginning and end points thereof.

14. The HDMI transmitting system according to claim 10, wherein the flag configures preambles transmitted in the control periods indicating a next data period is a data island period for transmitting audio data.

15. The HDMI transmitting system according to claim 10, wherein the HDMI transmitter instructs an HDMI receiver to turn off a display when the flag is set.

16. A system for transmitting audio data using HDMI, comprising:
an audio source, providing an audio input signal;
a transmitter, comprising:
an audio processor, receiving and processing the audio input signal from the audio source to generate audio data;
a mode indicator, reflecting if only the audio input signal is available or both audio and video input signals are available at the input of the HDMI transmitting system;
a video signal generator, generating a self-generated video signal if a video input signal is not available;
a video processor, receiving and processing the video input signal or the self-generated video signal to generate video data according to the mode indicator; and
an HDMI transmitter, receiving the audio and video data from the audio processor and video processor respectively, and outputting an HDMI signal carrying the audio data in data island periods and the video data in video data periods; and
a receiver, receiving the HDMI signal from the transmitter.

17. The system according to claim 16, wherein the self-generated video signal generated by the video signal generator in the transmitter is a static picture.

18. A system for transmitting audio data using a HDMI, comprising:
an audio source, providing an audio input signal;
a transmitter, comprising:
an audio processor, receiving and processing the audio input signal from the audio source to generate audio data; and
an HDMI transmitter, receiving the audio data from the audio processor and outputting an HDMI signal, comprises a mode indicator setting a flag if only the audio input signal is available at the input of the HDMI transmitting system, and outputting the HDMI signal comprising only data island periods and control periods if the flag is set; and
a receiver, receiving the HDMI signal from the transmitter.

19. The system according to claim 18, wherein the transmitter transmits the audio data in data island periods within horizontal blanking or vertical blanking periods.

20. The system according to claim 19, wherein the flag extends the horizontal blanking periods by configuring beginning and end points thereof.

21. The system according to claim 19, wherein the flag extends the vertical blanking periods by configuring beginning and end points thereof.

22. The system according to claim 18, wherein the flag configures preambles transmitted in the control periods indicating a next data period is a data island period.

23. The system according to claim 18, wherein the transmitter instructs the receiver to turn off a display when the flag is set.
